(19) United States
(12) Patent Application Publication
(10) Pub. No.: US 2005/0022073 A1
(43) Pub. Date: Jan. 27, 2005

(54) Microcomputer system

(75) Inventor: Yasunori Urashima, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/852,182

(22) Filed: May 25, 2004

(30) Foreign Application Priority Data
May 26, 2003 (JP) P2003-147406

(51) Int. Cl. G06F 11/00

(52) U.S. Cl. 714/54

(57) ABSTRACT

Error write detection circuit 4 provided in microcomputer system 1 detects chip select signal CS and write signal WR caused by a write instruction outputted in error from CPU 2 that is in a runaway state. Error write detection circuit 4 then sends an error write detection signal to interrupt control circuit 5 and reset circuit 6. Subsequently, CPU 2 interrupts a currently executing program in response to the error write detection signal so that CPU 2 can be released from the runaway state. Reset circuit 6 outputs a reset signal so that microcomputer system 1 is enabled to return to the initial state.

### FIELD OF THE INVENTION

This invention generally relates to a microcomputer system and, more particularly, to a microcomputer system capable of detecting a runaway of a central processor unit.

This application is based upon and claims the benefit of priority from the prior Japanese Patent Application No. 2003-147406, filed on May 26, 2003, the entire contents of which are incorporated herein by reference.

### BACKGROUND OF THE INVENTION

In a microcomputer system, electrical noise and defects of a software program cause a central processor unit (CPU) malfunction or a runaway state. A watch dog timer is well known as means for detecting such a runaway state. The watch dog timer starts at the execution of an application program and judges a runaway of the CPU when the watch dog timer is not cleared but overflows during a predetermined period of time.

The watch dog timer takes a long time until it overflows and the CPU executes a wrong instruction until the watch dog timer eventually judges a runaway of the CPU. As a result, data are written in a memory region where originally such data are not intended to be written so that necessary data may be destroyed or abnormal system operations may occur.

In order to prevent data from being written in error, conventionally, a microcomputer system is provided with runaway prevention means disclosed in Japanese Unexamined Patent Publication 2001-4311, for instance. The runaway prevention means always monitors address signals for a rewritable memory, compares them with preset addresses, and, if they coincide with each other, generates an interrupt demand signal for the CPU to stop its runaway.

The runaway prevention means, however, requires registers where preset addresses are written and comparators which compare address signals with the preset addresses. Where a plurality of preset addresses are required, the number of registers and comparators provided for the runaway prevention means should be that of the preset addresses. Thus, it poses a problem in increasing a scale of integrated circuits in the microcomputer system.

Further, it has another problem in which, for other than preset addresses, data may be written in a memory in error.

### SUMMARY OF THE INVENTION

Accordingly, the present invention is for solving the problems set forth above and provides a microcomputer system capable of returning the CPU from a runaway state to a normal one in a short time without addition of a large scale integrated circuit.

The first aspect of the present invention is directed to a microcomputer system provided with a central processor unit, a read only memory, an error write detection circuit for detecting a write signal sent from the central processor unit to the read only memory to generate an error write detection signal, an interrupt control circuit for interrupting the central processor unit in executing a program and/or a reset circuit for resetting the microcomputer system. The interrupt control circuit interrupts the central processor unit and/or the rest circuit resets the microcomputer system in response to the error detecting signal.

The second aspect of the present invention is directed to a microcomputer system provided with a central processor unit, a random access memory, a write control circuit for inhibiting the random access memory from writing data in accordance with a write inhibit signal sent from the central processor unit, an error write detection circuit for detecting a write signal sent in error from the central processor unit to the random access memory to generate an error write detection signal, an interrupt control circuit for interrupting the central processor unit in executing a program and/or a reset circuit for resetting the microcomputer system. The interrupt control circuit interrupts the central processor unit and/or the rest circuit resets the microcomputer system in response to the error detecting signal.

The third aspect of the present invention is directed to a microcomputer system provided with a central processor unit, a random access memory, a write inhibit data register for storing a write inhibit data signal sent from the central processor unit for the random access memory, a write control circuit for inhibiting the random access memory from writing data in response to the write inhibit data signal outputted from the write inhibit data register, an error write detection circuit for detecting a write signal sent in error from the central processor unit to the random access memory to generate an error write detection signal, an interrupt control circuit for interrupting the central processor unit in executing a program and/or a reset circuit for resetting the microcomputer system. The interrupt control circuit interrupts the central processor unit and/or the rest circuit resets the microcomputer system in response to the error detecting signal.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1A is a block diagram of a microcomputer system according to the first embodiment of the present invention;

FIG. 1B is a circuit diagram of an error write detection circuit shown in FIG. 1A;

FIG. 2A is a block diagram of a microcomputer system according to the second embodiment of the present invention;

FIG. 2B is a circuit diagram of a write control detection circuit shown in FIG. 2A;

FIG. 2C is a circuit diagram of an error write detection circuit shown in FIG. 2A;

FIG. 3A is a block diagram of a microcomputer system according to the third embodiment of the present invention; and

FIG. 3B is a circuit diagram of a write control circuit shown in FIG. 3A;

FIG. 3C is a circuit diagram of an error write detection circuit shown in FIG. 3A;

FIG. 4A is a block diagram of a microcomputer system modified to the third embodiment of the present invention; and

FIG. 4B is a circuit diagram of a write control circuit shown in FIG. 4A.

### DESCRIPTION OF THE PREFERRED EMBODIMENTS

Embodiments of the present invention will be explained below with reference to the attached drawings. It should be noted that the present invention is not limited to the embodiments but covers their equivalents. Throughout the attached drawings, similar or same reference numerals show similar, equivalent or same components.

First Embodiment

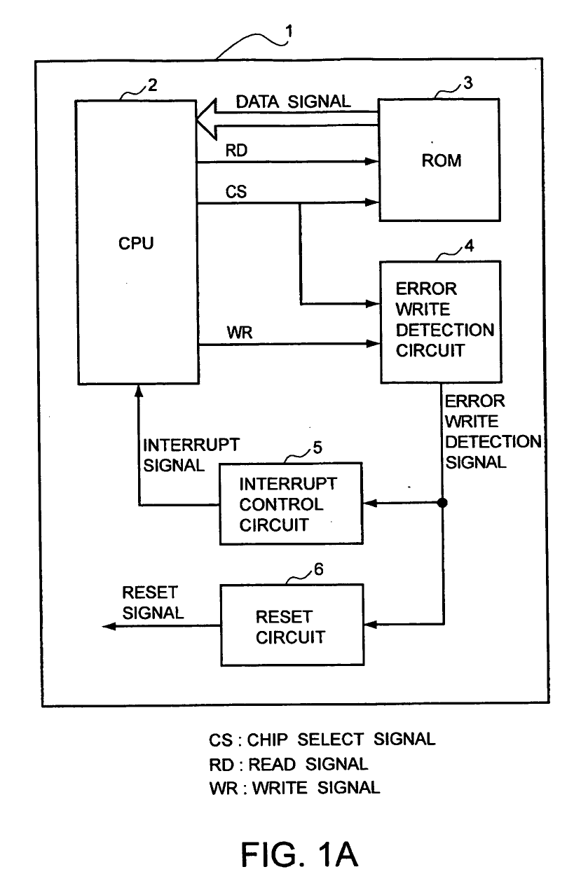

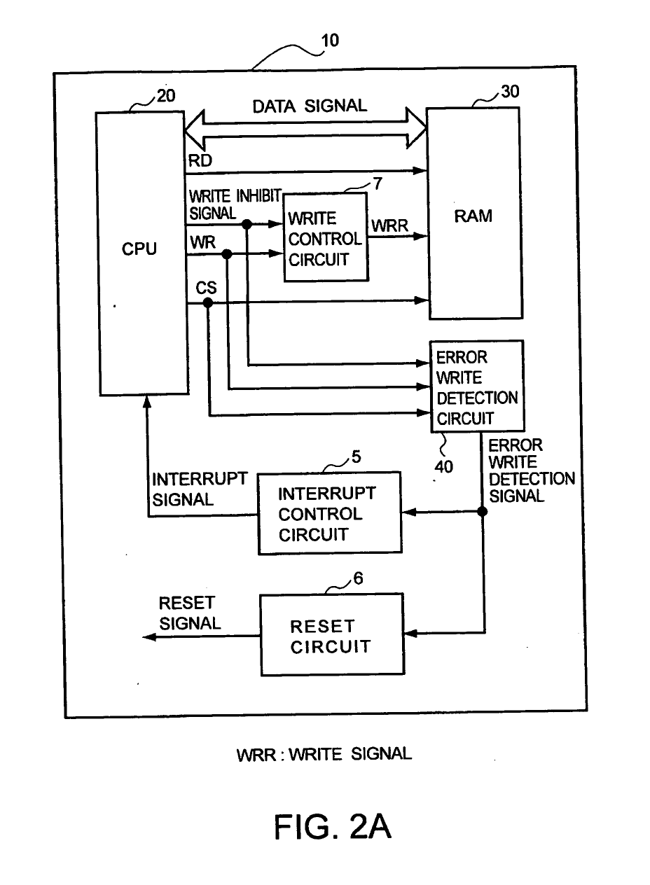

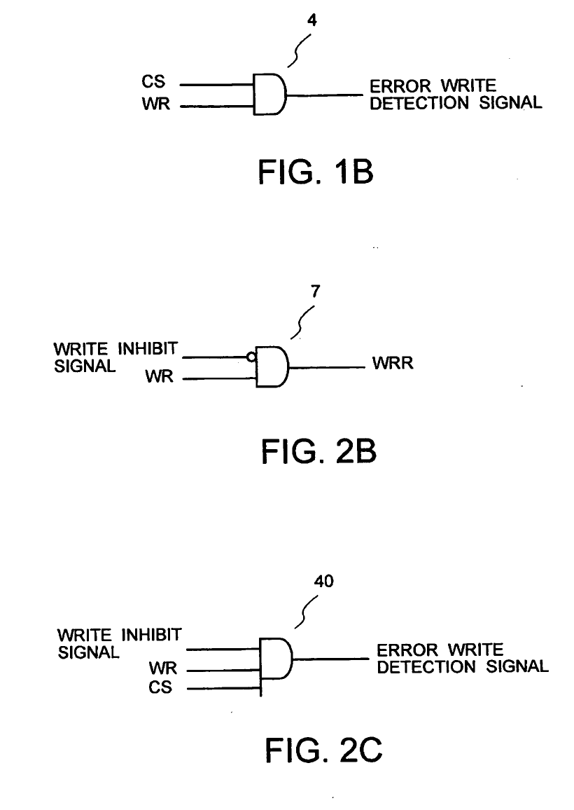

FIG. 1A is a block diagram of a microcomputer system according to the first embodiment of the present invention.

Microcomputer system 1 is provided with CPU 2, read-only memory ROM 3, error write detection circuit 4 for detecting write signals to write data in ROM 3 in error, and interrupt control circuit 5 and reset circuit 6 respectively to which an output is supplied from error write detection circuit 4.

Here, ROM 3 supplies its stored data signal to CPU 2 when ROM 3 receives both chip select signal CS and read signal RD.

CPU 2 supplies chip select signal CS and write signal WR to error write detection circuit 4. Since error write detection circuit 4 consists of an AND logic circuit as shown in FIG. 1B, error write detection circuit 4 outputs a write detection signal when receiving both chip select signal CS and write signal WR.

Where CPU 2 of microcomputer system 1 falls into a runaway state, CPU 2 provides ROM 3 with an erroneous write instruction which should never ordinarily happen. At the occurrence of such an erroneous write instruction, microcomputer system 1 carries out the following operations.

When CPU 2 generates erroneously a write instruction to ROM 3, CPU 2 outputs chip select signal CS to ROM 3 and write signal WR. Since error write detection circuit 4 is supplied with both chip select signal CS and write signal WR, error write detection circuit 4 outputs an error write detection signal.

In response to the error write detection signal, interrupt control circuit 5 outputs an interrupt signal to CPU 2. Upon receipt of the interrupt signal, CPU 2 interrupts the execution of its currently processing program. This interruption of the execution of processing program returns CPU 2 from the runaway state to its normal one.

Where an abnormal state of CPU 2, however, is due to runaway, it is not always guaranteed that CPU 2 will accept the interrupt signal. If CPU 2 does not accept it, reset circuit 6 outputs a reset signal for resetting entire microcomputer system 1. Thus, CPU 2 returns from its runaway state to an initial one.

According to microcomputer system 1 of the first embodiment of the present invention, even though CPU 2 falls into a runaway state, when an error write signal is inputted to ROM 3, the error write signal is immediately detected so that CPU2 can return to its normal state from the runaway one.

Second Embodiment

FIG. 2A is a block diagram of a microcomputer system according to the second embodiment of the present invention.

Microcomputer system 10 is basically the same in structure as microcomputer system 1 shown in FIG. 1A. Components shown in FIG. 2A with the same reference numerals as in FIG. 1A represent substantially the same or equivalent ones shown in FIG. 1A. Their descriptions are omitted but components different from those of FIG. 1A will be explained here.

Being different from microcomputer system 1 shown in FIG. 1A, microcomputer system 10 is provided with a random access memory RAM 30.

In order to control to write data in RAM 30, write control circuit 7 is newly provided. Write control circuit 7 consists of an AND logic circuit with two input terminals as shown in FIG. 2B. The terminals of write control circuit 7 are supplied with write signal WR and a write inhibit signal from CPU 2, and outputs write signal WRR. A small circle indicated at the upper input terminal represents an inverter, which inverts the write inhibit signal and supplies the inverted write inhibit signal to upper terminal. Thus, when no write inhibit signal is applied to write control circuit 7, write signal WR is transmitted as write signal WRR. When write inhibit signal is applied, however, write control circuit 7 inhibits write signal WR from being transmitted as write signal WRR so that data are not written in RAM 30.

Error write detection circuit 40 is also different from error write detection circuit 4 and consists of an AND logic circuit with three input terminals as shown in FIG. 2C. The input terminals are supplied with the write inhibit signal, write signal WR and chip select signal CS of RAM 30, respectively. When error write detection circuit 40 receives the write inhibit signal, chip select signal CS of RAM 30 and write signal WR, error write detection circuit 40 outputs an error write detection signal to interrupt control circuit 5 and reset circuit 6.

In this microcomputer system 10, CPU 20 sometimes falls into a runaway state and gives a write instruction to RAM 30 inhibited from writing data. When such an error write instruction is generated, microcomputer system 10 operates in the following way.

When RAM 30 is inhibited from writing data but CPU 20 erroneously sends a write signal to RAM 30, CPU 20 also supplies RAM 30 with chip select signal CS and write signal WR. Since CPU 20 further supplies error write detection circuit 40 with chip select signal CS, write signal WR and the write inhibit signal, error write detection circuit 40 outputs an error write detection signal.

In response to the error write detection signal, interrupt circuit 5 provides CPU 20 with an interrupt signal. Upon receipt of the interrupt signal, CPU 20 interrupts a currently executing program. After the interruption of the executing program, CPU 20 returns from the runaway state to the normal one.

However, since CPU 20 is in an abnormal state due to the runaway occurring, it is not always guaranteed that the interrupt signal is accepted. If the interrupt signal is not accepted, reset circuit 6 outputs a reset signal so that microcomputer system 10 is reset throughout and so that CPU 20 returns from the runaway state to the initial one.

As set forth above, according to microcomputer system 10, when CPU 20 falls into a runaway state, if an error write signal is outputted to RAM 30 inhibited from writing data, the error write signal is detected so that CPU 20 can return from the runaway state to the initial one.

Third Embodiment

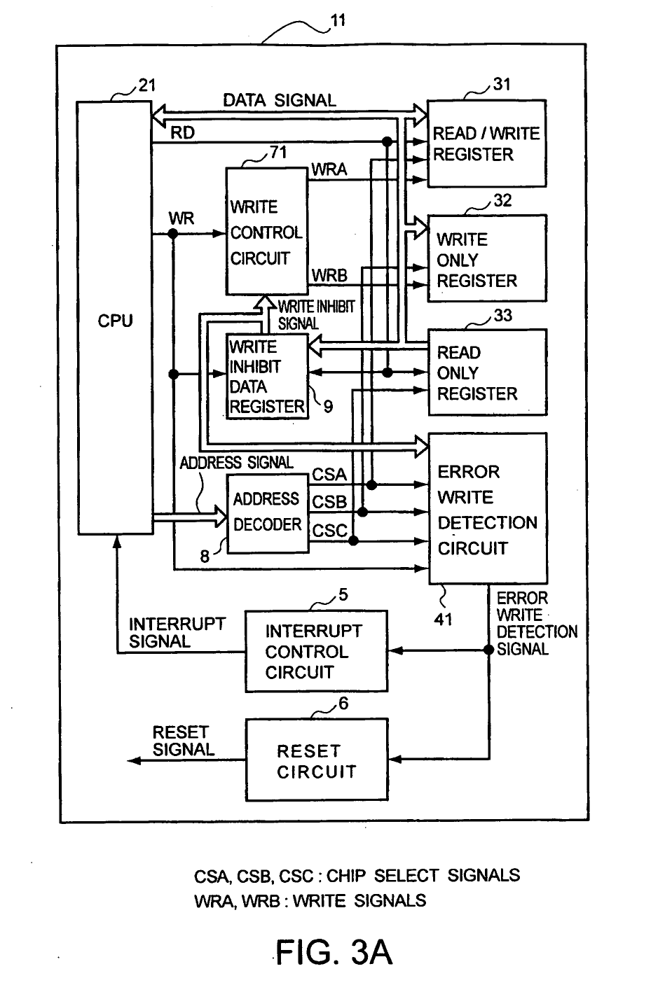

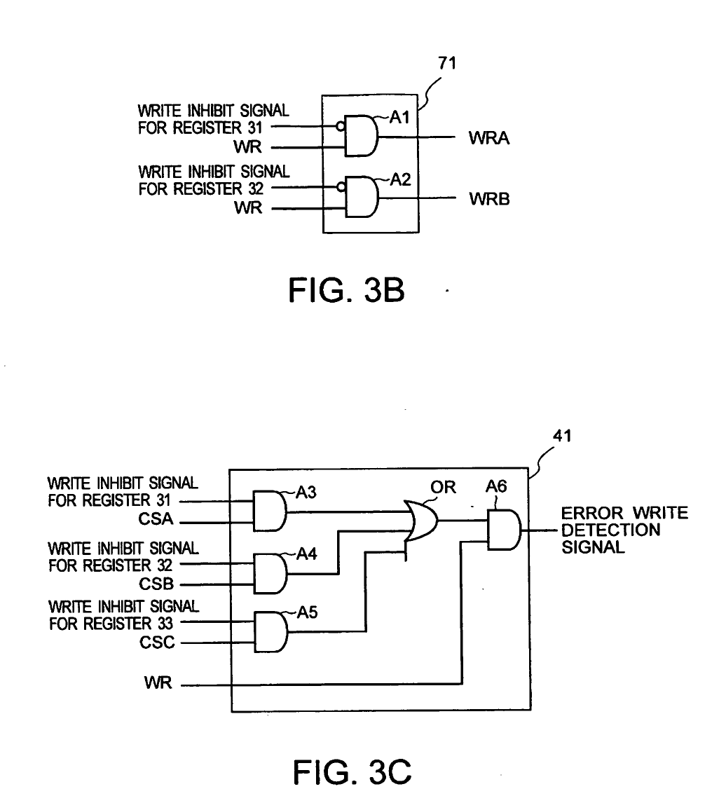

FIG. 3A is a block diagram of a microcomputer system according to the third embodiment of the present invention.

In this embodiment, registers are used for memories. By way of example, microcomputer system 11 uses read/write register 31 to read and write data, write only register 32 only to write data, and read only register 33 only to read data.

Microcomputer system 11 is also provided with address decoder 8 that generates chip select signals CSA, CSB and CSC for read/write register 31, write only register 32 and read only register 33, respectively.

Further, microcomputer system 11 is provided with write control circuit 71 and write inhibit data register 9. Write control circuit 71 controls to write data in read/write register 31 and write only register 32. Write inhibit data register 9 supplies write control circuit 71 with a write inhibit signal.

A write inhibit signal included in a data signal from CPU 21 is written in write inhibit data register 9 in accordance with write signal WR provided to read/write register 31 and write only register 32. Write inhibit data register 9 outputs a write inhibit signal to read/write register 31 and write only register 32 in accordance with read signal RD.

Write control circuit 71 consists of two AND logic circuits A1 and A2 as shown in FIG. 3B. AND logic circuit A1 has two input terminals to receive an inverted write inhibit signal for register 31 and write signal WR, respectively. A small circle indicated at the upper terminal represents an inverter, which inverts the write inhibit signal for register 31. AND logic circuit A1 outputs write signals WRA to read/write register 31 based on write signal WR from CPU 21 and the write inhibit signal from write inhibit data register 9. Similarly, AND logic circuit A2 also has two input terminals to receive an inverted write inhibit signal for write only register 32 and write signal WR, respectively. AND logic circuit A2 outputs write signals WRB to write only register 32 based on write signal WR from CPU 21 and the write inhibit signal from write inhibit data register 9.

When write inhibit data register 9 outputs no write inhibit signal, write control circuit 71 directly transmits write signal WR as write signals WRA and WRB to read/write register 31 and write only register 32, respectively. However, when write inhibit data register 9 outputs the write inhibit signal, write control circuit 71 stops transmitting write signals WRA and WRB to read/write register 31 and write only register 32, respectively. Thus, read/write register 31 and write only register 32 are inhibited from writing data signals.

In other words, when write/read register 31 receives chip select signal CSA and write signal WRA, write/read register 31 writes data signals from CPU 21. However, when write/read register 31 receives the write inhibit signal, write/read register 31 is in an inhibited state and cannot write data signals from CPU 21. Further, when write/read register 31 receives chip select signal CSA and read signal RD, write/read register 31 reads out data and sends the same to CPU 21.

Similarly, when write only register 32 receives chip select signal CSB and write signal WRB, write only register 32 writes data signals from CPU 21. However, when write only register 32 receives the write inhibit signal, write only register 32 is in the inhibited state so that write only register 32 cannot write data signals from CPU 21.

Further, when read only register 33 receives chip select signal CSC and read signal RD, read only register 33 reads out data and sends the same to CPU 21. However, write signal WR is not inputted to read only register 33 from the outset.

Error write detection circuit 41 consists of AND logic circuits A3-A6 and OR logic circuit OR as shown in FIG. 3C. AND logic circuit A3 has two input terminal to receive the write inhibit signal for register 31 and address signal CSA, respectively. AND logic circuit A4 also has two input terminals to receive the write inhibit signal for write only register 32 and address signal CSB. Further, AND logic circuit A5 has two input terminals to receive the write inhibit signal for register 33 and address signal CSC. Output signals of AND logic circuits A3-A5 are supplied to OR logic circuit OR. AND logic circuit A6 has two input terminals to receive an output signal from OR logic circuit OR and write signal WR and an output terminal for an error write detection signal.

Error write detection circuit 41 outputs the error detection signal to interrupt control circuit 5 and reset circuit 6 in the following events: (1) when inhibited read/write register 31 is instructed to execute a writing operation, i.e., when read/write register 31 receives the write inhibit signal, address signal CSA and write signal WR; (2) when inhibited write only register 32 is instructed to execute a writing operation, i.e., when write only register 32 receives the write inhibit signal, address signal CSB and write signal WR; and (3) when read only register 33 is instructed to execute a writing operation, i.e., when read only register 33 receives address signal CSC and write signal WR.

Interrupt control circuit 5 is identical to that in the first embodiment and its explanation is omitted here.

In this microcomputer system 11, CPU 21 sometimes falls into a runaway state and gives a write instruction to read/write register 31 or write only register 32 even when read/write register 31 or write only register 32 is inhibited from writing data, or read only register 33. When such an error write instruction is generated, microcomputer system 11 operates as follows:

When read/write register 31 or write only register 32 is inhibited from writing data but CPU 21 erroneously gives a write instruction to read/write register 31, write only register 32 or read only register 33, CPU 21 also outputs chip select signal CSA, CSB or CSC and write signal WR. Since error write detection circuit 41 is supplied with chip select signal CSA, CSB or CSC and write signal WR, error write detection circuit 41 outputs an error write detection signal.

In response to the error write detection signal, interrupt circuit 5 provides CPU 21 with an interrupt signal. Upon receipt of the interrupt signal, CPU 21 interrupts a current executing program. After the interruption of the executing program, CPU 21 returns from the runaway state to the normal one.

However, since CPU 21 is in an abnormal state due to the runaway occurring, it is not always guaranteed that the interrupt signal is accepted. If the interrupt signal is not accepted, reset circuit 6 outputs a reset signal so that microcomputer system 11 is reset throughout and so that CPU 21 returns from the runaway state to the initial one.

As set forth above, according to microcomputer system 11, when read/write register 31 or write only register 32 is inhibited from writing data but CPU 21 falls into a runaway state, if an error write signal is outputted to read/write register 31, write only register 32 or read only register 33, the error write signal is detected so that CPU 21 can return from the runaway state to the initial one.

Modification to the Third Embodiment

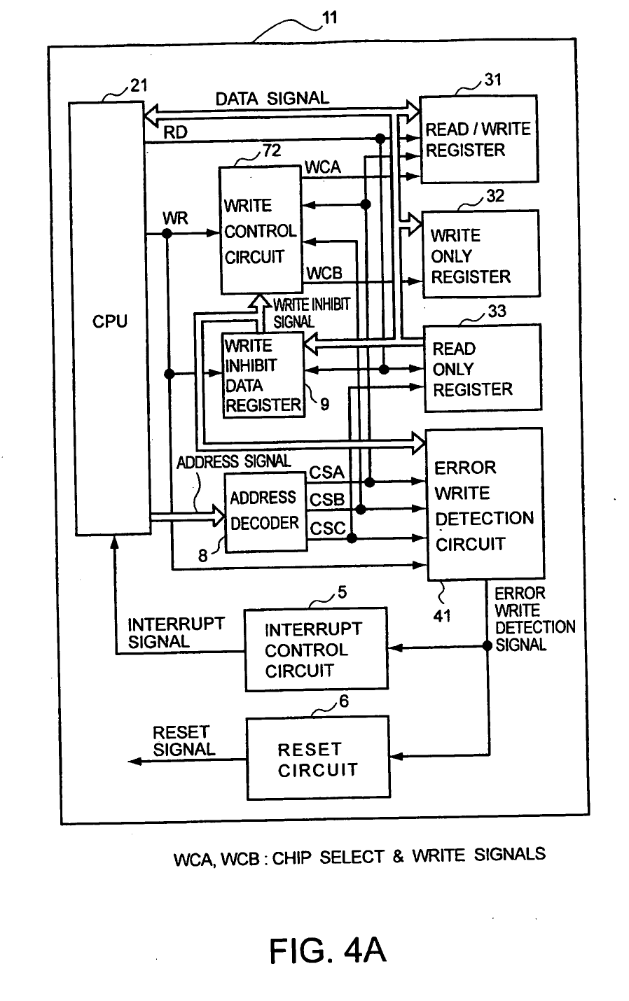

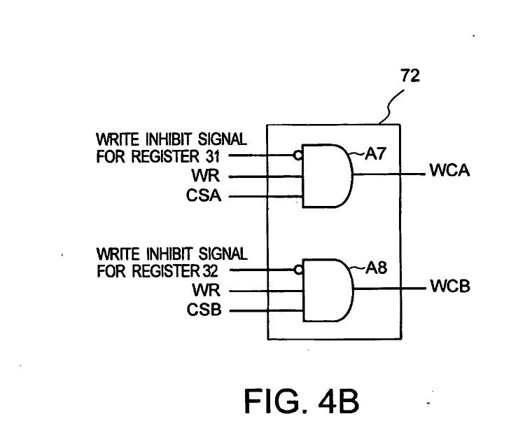

FIG. 4A is a block diagram of a microcomputer system 11 modified to the third embodiment of the present invention.

There are structural differences between the microcomputer systems shown in FIGS. 3A and 4A. As shown in FIG. 4A, write control circuit 72 is basically the same as write control circuit 71 shown in FIG. 3 but write control circuit 72 is additionally supplied with chip select signals CSA and CSB, read/write register 31 is also additionally supplied with chip select/write signal WCA and write only register 32 is further additionally supplied with chip select/write signal WCB.

Here, write control circuit 72 consists of two AND logic circuits A7 and A8 as shown in FIG. 4B. AND logic circuit A7 is provided with three input terminals to receive inverted write inhibit signal for read/write register 31, write signal WR from CPU 21 and chip select signal CSA, respectively, and an output terminal to supply chip select/write signal WCA to read/write register 31. AND logic circuit A8 is also provided with three input terminals to receive inverted write inhibit signal for write only register 32, write signal WR from CPU 21 and chip select signal CSB, respectively, and an output terminal to supply chip select/write signal WCB to read/write register 32. Thus, write control circuit 72 outputs chip select/write signals WCA and WCB, respectively, to read/write register 31 and write only register 32 when write control circuit 72 is further supplied with write signal WR from CPU 21 while receiving chip select signals CSA and CSB, respectively.

When the write inhibit signal is generated, no chip select/write signals WCA and WCB are outputted.

Since chip select/write signal WCB is used, chip select signal CSB is no longer required for write only register 32.

According to the present invention, a microcomputer system detects an instruction to write data in inhibited memory means or components that do not write data from the outset and can return a CPU from its runaway state to the normal or initial one

Although the invention has been described with a certain degree of particularity, it is understood that the present disclosure of the preferred form has been changed in the details of construction and the combination and arrangement of components may be resorted to without departing from the spirit and the scope of the invention as hereinafter claimed. Some components of the embodiments may be eliminated or various components from different embodiments may also be combined.

1. A microcomputer system comprising:
a central processor unit;
a read only memory;
an error write detection circuit for detecting a write signal sent from said central processor unit to said read only memory to generate an error write detection signal; and
an interrupt control circuit for interrupting said central processor unit in executing a program in response to the error write detection signal from said error write detection circuit.

2. A microcomputer system comprising;
a central processor unit;
a read only memory;
an error write detection circuit for detecting a write signal sent from said central processor unit to said read only memory to generate an error write detection signal; and
a reset circuit for resetting said microcomputer system in response to the error write detection signal from said error write detection circuit.

3. A microcomputer system comprising:
a central processor unit;
a random access memory;
a write control circuit for inhibiting said random access memory from writing data in accordance with a write inhibit signal sent from said central processor unit;
an error write detection circuit for detecting a write signal sent in error from said central processor unit to said random access memory to generate an error write detection signal; and
an interrupt control circuit for interrupting said central processor unit in executing a program in response to the error write detection signal from said error write detection circuit.

4. A microcomputer system comprising:
a central processor unit;
a random access memory;
a write control circuit for inhibiting said random access memory from writing data in accordance with a write inhibit signal sent from said central processor unit;
an error write detection circuit for detecting a write signal sent in error from said central processor unit to said random access memory to generate an error write detection signal; and
a reset circuit for resetting said microcomputer system in response to the error write detection signal from said error write detection circuit.

5. A microcomputer system comprising:
a central processor unit;
a random access memory;
a write inhibit data register for storing a write inhibit data signal sent from said central processor unit for said random access memory;
a write control circuit for inhibiting said random access memory from writing data in response to the write inhibit data signal outputted from said write inhibit data register;
an error write detection circuit for detecting a write signal sent in error from said central processor unit to said random access memory to generate an error write detection signal; and
an interrupt control circuit for interrupting said central processor unit in executing a program in response to the error write detection signal from said error write detection circuit.

6. A microcomputer system comprising:
a central processor unit;
a random access memory;
a write inhibit data register for storing a write inhibit data signal sent from said central processor unit for said random access memory;
a write control circuit for inhibiting said random access memory from writing data in response to the write inhibit data signal outputted from said write inhibit data register;
an error write detection circuit for detecting a write signal sent in error from said central processor unit to said random access memory to generate an error write detection signal; and
a reset circuit for resetting said microcomputer system in response to the error write detection signal from said error write detection circuit.

7. A microcomputer system according to claim 3, wherein said write control circuit inhibits the write signal from transmitting from said central processor unit to said random access memory in accordance with the write inhibit signal.

8. A microcomputer system according to claim 4, wherein said write control circuit inhibits the write signal from transmitting from said central processor unit to said random access memory in accordance with write inhibit signal.

9. A microcomputer system according to claim 5, wherein said write control circuit inhibits the write signal from transmitting from said central processor unit to said random access memory in accordance with the write inhibit signal.

10. A microcomputer system according to claim 6, wherein said write control circuit inhibits the write signal from transmitting from said central processor unit to said random access memory in accordance with the write inhibit signal.

11. A microcomputer system according to claim 3, wherein said interrupt control circuit generates an interrupt signal to interrupt said central processor when receiving the error write detection signal.

12. A microcomputer system according to claim 4, wherein said interrupt control circuit generates an interrupt signal to interrupt said central processor when receiving the error write detection signal.

13. A microcomputer system according to claim 5, wherein said interrupt control circuit generates an interrupt signal to interrupt said central processor when receiving the error write detection signal.

14. A microcomputer system according to claim 2, wherein said reset circuit generates a reset signal to reset said microcomputer system when receiving the error write detection signal from said error write detection circuit.

15. A microcomputer system according to claim 4, wherein said reset circuit generates a reset signal to reset said microcomputer when receiving the error write detection signal from error write detection circuit.

16. A microcomputer system according to claim 6, wherein said reset circuit generates a reset signal to reset said microcomputer system when receiving the error write detection signal from error write detection circuit.
